(19) United States
(12) Patent Application Publication
(10) Pub. No.: US 2017/0193834 A1
(43) Pub. Date: Jul. 6, 2017

(54) COMPUTER IMPLEMENTED NETWORK ENABLED SYSTEM FOR STRUCTURED AND PROGRESSIVE ONLINE PEER-BASED LEARNING AND LEARNING ASSESSMENT

(71) Applicant: Tata Consultancy Services Limited, Mumbai (IN)

(72) Inventors: Ashok MAHARAJ, Chennai (IN); Renuga SARASWATHY, Chennai (IN); Sahil PRAJAPATI, Chennai (IN); Suganya NANDAKUMAR, Chennai (IN); Dilip Murugesan KUPPUSAMY, Chennai (IN); Venkatakrishnan RANGANATHAN, Chennai (IN)

(73) Assignee: Tata Consultancy Services Limited, Mumbai (IN)

(21) Appl. No.: 15/078,448

(22) Filed: Mar. 23, 2016

(30) Foreign Application Priority Data
Jan. 4, 2016 (IN) 201621000221

(51) Int. Cl. G09B 7/00

(52) U.S. Cl. CPC G09B 7/00

(57) ABSTRACT

The present disclosure envisages a computer implemented network enabled system for structured and progressive online learning and learning assessment. The platform includes a learning assessment arc and a user point and scorecard badge repository that are automatically calibrated to reflect the user's learning progress and competency development in different subjects as users engage in various system activities such as creating or viewing or updating learning content, questions or learning assessments, or take learning assessments created by other users or by the system and/or provide quality rating for questions to improve the quality of questions and learning assessments in the system.

### PRIORITY CLAIM

This U.S. present application claims priority under 35 U.S.C. §119 to India Application No. 201621000221, filed on Jan. 4, 2016. The entire contents of the aforementioned application are incorporated herein by reference.

### TECHNICAL FIELD

The present disclosure generally relates to the field of learning systems, and more particularly, to method and system for structured and progressive online learning and learning assessment.

### BACKGROUND

Online (electronic) learning has evolved immensely in recent times. One example of such advancements in the online learning industry is the multitude of Massive Open Online Courses (MOOCs) platforms in the market. These cater to the diverse educational needs of students, working professionals, and people who are interested in picking up or enhancing their skills in specific subject areas. The courses are designed to help learners make systematic progress and a typical structure of the course is in the form of a set of modular units and sub-units containing different forms of learning content. However, since these systems are targeted towards a large audience setup, they suffer from a lack of from personalized teaching addressed towards the learning preferences and styles of different users.

Most learning systems depend on periodic assessments of learning progress of users by including a learning assessment component which poses a set of questions to the user pertaining to the learning content, at different steps during the course and at its completion. Traditional learning assessment tests created and administered by the teacher are focused on testing the learner's knowledge subjectively and objectively, more from the learning content creator's perspective. Further, in a traditional learning assessment, each user develops their learning based on the user's individualistic capability and comprehension of the content. Thus it becomes important to have a computer implemented network enabled system that enhances the learning and learning assessment of the user in a structured and progressive way by providing a gamified platform for the user to engage with the other users and participate in learning assessments created by other users or by the system and related activities.

### SUMMARY

Embodiments of the present disclosure present technological improvements as solutions to one or more of the above-mentioned technical problems recognized by the inventors in conventional systems. For example, in one embodiment a learning content repository for storing a plurality of learning contents; a user repository for storing a plurality of user profiles wherein a first user is designated as a moderator and a second user has a user level relative to the first user, and wherein one or more second users is at least one of a learning content creator, a learning content reviewer, a question creator, a question reviewer, a learning assessment creator, a learning assessment reviewer and a learning assessment taker; a question bank repository for storing a plurality of questions and at least one answer to each of said questions from amongst the plurality of questions; a learning assessment repository for storing a plurality of learning assessments as created by the second user from a plurality of users; a user course repository for storing a plurality of learning courses registered for by the second user from said user repository, number of learning content assets from said learning content repository viewed or created or reviewed by the second user, number of learning assessments created by or taken or reviewed by the second user, the second user's score in each learning assessment, number of learning assessment questions created or reviewed by the second user in said question bank repository, and a competency indicator which indicates the current and target skill level of the second user in the particular course; a duplicate question checker configured to check if a new question created by the question creator from said user repository matches any question in said question bank repository and send a system message to the question creator in case of a match; a learning assessment selection processor configured to cooperate with said learning assessment repository to fetch a learning assessment from said learning assessment repository selected by the learning assessment taker from said user repository based on selection of the option by the learning assessment taker to take a learning assessment as created by a learning assessment creator and based on the learning assessment taker's competency indicator information from said user course repository; a learning assessment generator configured to create a learning assessment by fetching a set of questions from said question bank repository among the questions tagged with star rating, randomizing the said questions, and aggregating them into a system-generated learning assessment to be presented to a learning assessment taker, based on selection of the option by the learning assessment-taker to take a system-generated learning assessment, on the course being undertaken by the learning assessment taker, the type of assessment selected and the competency indicator information of the learning assessment taker from said user course repository; a learning assessment question response evaluator configured in the system to record the response provided by the learning assessment taker from said user repository to each question in the learning assessment from said learning assessment repository or generated by the learning assessment generator and compare it with the available response for said question in said question bank repository, assign a score based on the correctness or incorrectness of the response and record the question quality rating for the said question in the question bank repository as provided by the learning assessment-taker; a question quality rating rationalizer configured to cooperate with said question bank repository and said user repository to rationalize the question quality rating for each question in said question bank repository by adjusting at a question level, the question quality ratings provided by each of the plurality of the learning assessment takers by comparing the level of each learning assessment-taker relative to the level of the first user as available in said user repository, and then further averaging the question quality rating among the number of quality ratings received for said question in said question bank repository; a learning assessment rating calculator configured to calculate the aggregate score of the learning assessment taken by the learning assessment taker from said user repository by aggregating the scores for each question in the said learning assessment; a user point and badge scorecard repository configured to show the points and badges accrued by the second user on the completion of different activities pertaining to creating, viewing or updating learning content in said learning content repository, creating, taking or reviewing a learning assessment in said learning assessment repository, receiving a question quality rating for a question in said question bank repository, such that the points and badges accrued by the second user results in enhanced user level relative to the first user in said user repository and unlocks privileges that the second user was earlier not allowed to do; and a learning assessment arc configured to interact with said user repository, said user course repository, said learning assessment repository, and said user point and badge scorecard repository to provide real-time analytics to reflect learning progress of the second user at a granular level.

In accordance with the present disclosure, the system comprises a user repository to store user profiles without limitation registration information, user level relative to the moderator, incentive-based points received by the user, user's progress within a group or system. It also includes a user course repository for storing information pertaining to the courses that a user has registered for and is undertaking, number of learning content assets created or reviewed by the user, number of learning assessments generated by or taken or reviewed by the user, the user's score in each learning assessment, number of learning assessment questions generated or reviewed by a user, current and target competency indicator of the user in each course undertaken.

The system further comprises a learning content repository for storing a plurality of learning content assets further categorized by learning category or course, a learning assessment repository for storing the set of learning assessments pertaining to a learning content as created by and tagged to the learning assessment creator and with a learning assessment content tag to indicate which learning assessment it is associated with, a question bank repository for storing the set of questions contributing to a learning assessment with tagging to indicate the question type, a learning content tag, at least one answer, a question creator tag to indicate which user has created the question and a complexity rating to determine the complexity of the question, a question quality rating and a question score. A duplicate question checker possesses functional elements to detect whether new questions created by a user match questions in the question bank repository and flag the user creating new questions if there is a match. A learning assessment selection processor is configured to cooperate with the learning assessment repository to fetch a learning assessment from the learning assessment repository as selected by the learning assessment taker based on the user's competency indicator information (current and target) from the user course repository. A learning assessment generator is configured to fetch set of questions among the ones with the star rating from the question bank repository, randomize the questions, and aggregate them into a system generated learning assessment to be presented to a learning assessment taker, based on information on the course being undertaken by the user and the competency indicator information (current and target) from the user course repository. A learning assessment question response evaluator is configured in the system to record the response provided by the user to a question and compare it to the available response for the question in the question bank and assign a score for correct/incorrect answer and recording the question quality rating as provide by the learning assessment taker. A question quality rating rationalizer possesses functional elements to cooperate with the question bank repository and the user repository to rationalize the question quality rating by adjusting at a question level, the question quality ratings provided by each of the learning assessment takers by comparing the level of each of the learning assessment takers relative to the level of the moderator as available in the user repository, and then further averaging the question quality rating among the number of quality ratings received for a question. A learning assessment rating calculator is configured to develop an aggregate score for a learning assessment as taken by the user by aggregating the score of each question in the learning assessment based on the user responses. It further comprises a user point and badge scorecard repository to score the points and badges accrued by the user during the course of engaging with different activities in the system as mentioned above. It further comprises a learning assessment arc to measure the learning progress of the user at a granular level and present real-time analytics of the learning progress of the user at a granular level.

In accordance with the present disclosure, a method for providing structured and progressive online learning and learning assessment is envisaged. The method, in accordance with the present disclosure comprising: storing, in a learning content repository, a plurality of learning contents; storing, in a user repository, a plurality of user profiles wherein a first user is designated as a moderator and a second user has a user level relative to the first user and one or more second users is at least one of a learning content creator, a learning content reviewer, a question creator, a question reviewer, a learning assessment creator, a learning assessment reviewer and a learning assessment taker; storing, in a question bank repository a plurality of questions and at least one answer to each of said questions; storing, in a learning assessment repository, a plurality of learning assessments as created by the second user from a plurality of users; storing, in a user course repository, a plurality of learning courses registered for by the second user from said user repository, number of learning content assets from said learning content repository viewed or created or reviewed by second user, number of learning assessments created by or taken or reviewed by the second user, the second user's score in each learning assessment, number of learning assessment questions created or reviewed by second user in said question bank repository, a competency indicator which indicates the current and target skill level of the second user in the particular course; checking, using a duplicate question checker, if a new question created by the question creator from said user repository matches any question in said question bank repository and sending a system message to the second user in case of a match; prompting the second user to select among a number of tasks that the system allows and confirm if he would like to create, view or review learning content in said learning content repository, take a test/quiz or any other form of learning assessment from said learning assessment repository, create or review a test/quiz or any other form of learning assessment into said learning assessment repository or create questions or review the questions in said question bank repository to provide question quality rating; fetching using a learning assessment selection processor, a learning assessment from said learning assessment repository and presenting it to the learning assessment taker from said user repository based on selection of the option by the learning assessment taker to take a learning assessment as created by a learning assessment-creator from said user repository and based on the learning assessment taker's competency indicator information from said user course repository; using a learning assessment generator to fetch one or more from a plurality of questions from the said question bank repository tagged with star rating, randomizing the said questions, and aggregating them into a system-generated learning assessment to be presented to a learning assessment taker, based on selection of the option by the learning assessment-taker to take a system-generated learning assessment, on the course being undertaken by the learning assessment taker user, the type of assessment selected and the competency indicator information of the learning assessment taker from said user course repository; using the learning assessment question response evaluator to record the response of the learning assessment taker from said user repository to each question in the learning assessment from said learning assessment repository or generated by the learning assessment generator and compare it with the available response for the said question in the said question bank repository, assign a score based on the correctness or incorrectness of the response and record the question quality rating for the said question in the question bank repository as provided by the learning assessment-taker; using the question quality rating rationalizer to rationalize the question quality rating for each question in said question bank repository by adjusting at a question level, the question quality ratings provided by each of the plurality of learning assessment-takers by comparing the level of each learning assessment taker relative to the level of the first user as available in the said user repository, and then further averaging the question quality rating among the number of quality ratings received for said question in said question bank repository; using the learning assessment rating calculator to calculate the aggregate score of the learning assessment taken by the learning assessment taker from said user repository by aggregating the scores for the each question in the said learning assessment; storing, in a user point and badge scorecard repository, the points and badges accrued by the second user on the completion of different activities pertaining to creating, viewing or updating learning content in said learning content repository, creating, taking or reviewing a learning assessment in said learning assessment repository, receiving a quality rating for a question in said question bank repository, such that the points and badges accrued by the second user results in enhanced user level relative to the first user in said user repository and unlocks privileges that the second user was earlier not allowed to do; and automatically calibrating a learning assessment are to interact with said user course repository, said learning assessment repository and said user point and badge scorecard repository to provide real-time analytics to reflect learning progress of the second user at a granular level.

### BRIEF DESCRIPTION OF THE ACCOMPANYING DRAWINGS

The computer implemented network enabled system for structured learning and learning assessment will now be explained in relation to the non-limiting accompanying drawings, in which:

FIG. 1 illustrates a schematic of a computer implemented network enabled system for structured and progressive online learning and learning assessment in accordance with the present disclosure;

FIG. 2 illustrates an exemplary flowchart for depicting the steps taken by the system 100 of FIG. 1, in accordance with the present disclosure; and

FIGS. 3 A and 3 B illustrates a flowchart for a method of implementation of the system 100 of FIG. 1, in accordance with the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The computer implemented network enabled structured learning and learning assessment will now be described with reference to the accompanying drawings, which do not restrict the scope and ambit of the present disclosure. The description is provided purely by the way of illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The description hereinafter, of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Described here are specific terms as used in the specification, in addition to those expressed in the art. The expression ‘user’ used hereinafter in the specification refers to a user, registered with the learning assessment platform by submitting user's credentials in a predefined registration form. It represents an administrator, a moderator and/or any other participating user who interacts with the system to view, create or review learning content assets, create and take learning assessments, create or review learning assessment questions while viewing the content. The user may hence be referred to as learning content creator, learning content reviewer, learning assessment creator, learning assessment taker, learning assessment reviewer or a question creator or a question reviewer throughout this specification. While references to the user may include ‘he/his’ throughout the specification, it may be interpreted to be extended to ‘she/her’ at any reference point.

The expression ‘learning content’ used hereinafter in the specification refers to content assets in the system used for the purpose of acquiring knowledge and skill in a given course, a subject matter, a language and/or a topic. It may be interchangeably referred to as content or learning content asset and may include but not limited to multimedia content in the form of videos, documents, audio files, or multiplayer online games, further categorized by learning category or course. Learning content may be created or reviewed by any user registered in the system.

The expression ‘learning assessment’ used hereinafter in the specification refers to a form of testing the user's learning progress for a specific learning content, the learning assessment may be in the form of a quiz, objective test or any form where the user provides a set of responses to a set of questions pertaining to the learning content. The learning assessment may be a user-created learning assessment and stored in the system or a system generated assessment that is dynamically created based on user preferences. The terms ‘quiz’ or ‘learning assessment’ may be used interchangeably in the rest of the document. The expression ‘question bank’ used hereinafter in the specification refers to a set of questions that can be stored in the system for a specific learning content.

The expression ‘learning assessment arc’ used hereinafter in the specification refers to a measurement module, a dashboard or a meter that provides real-time analytics to track at a granular level, the learning process of each user in terms of the number of courses taken by the user, number of learning assessments generated by the user, number of learning assessments taken by the user, the time user has spent on the course material, how many questions he/she has generated, what is his score in the different learning assessments he/she has undertaken, how many learning assessment questions he/she has provided quality feedback for, how many points and badges he has secured and his learning curve in terms of upward shift of the competency indicator and user level relative to the moderator.

The expression ‘computer’ used hereinafter in the specification refers to a desktop, mobile device, tablet and/or similar electronic devices. The expression ‘network’ used hereinafter in the specification refers to a computer network, Internet, Intranet, a local area network (LAN), a wide area network (WAN), a metropolitan area network (MAN), a cellular network and a wireless network.

The present disclosure includes a computer implemented network enabled system and method for structured and progressive online learning and learning assessment. The system acts as a gamified learning aid for progressive online learning and learning assessment of the user by enabling systemic collaboration among different users and allowing them to create, review or update learning content, create learning assessments which the users can take and vice versa at the time of viewing learning content for different sections/sub-units of a course, create and review the learning assessment questions, all intended to enhance the user's knowledge and comprehension in a course. It automates learning assessment in line with different user mastery levels, unique learning preferences and learning styles. It provides an automated, efficient and comprehensive method to generate, collect, mature, randomize and disseminate the learning assessment questions to users in an efficient and veracious way to ensure that assessment is done from learner's perspective. It also ensures ‘learning by doing’ and granular and effective measurement and real-time analytics of the learner's progress using the digitized and intelligent learning assessment arc.

The present disclosure includes a computer implemented network enabled structured learning and learning assessment and is oriented towards enabling user learning in line with different user mastery levels, unique learning preferences and learning styles, at the same time drawing upon the mastery of other users by way of participating in different activities contributing to such learning. The system is accessible via a network and is incorporated with social networking features to assist users to connect or collaborate with other users of the system via the learning assessments. New users of the system are required to register themselves by providing user registration information in a pre-determined user-registration form before viewing, updating or creating content and/or creating, taking, reviewing learning assessments. In accordance with the present disclosure, the system is enabled to receive and store biometric information from the user during the registration process. This biometric information is used in verifying the legitimacy of the user who wishes to login into the system for the purpose of carrying out learning assessments.

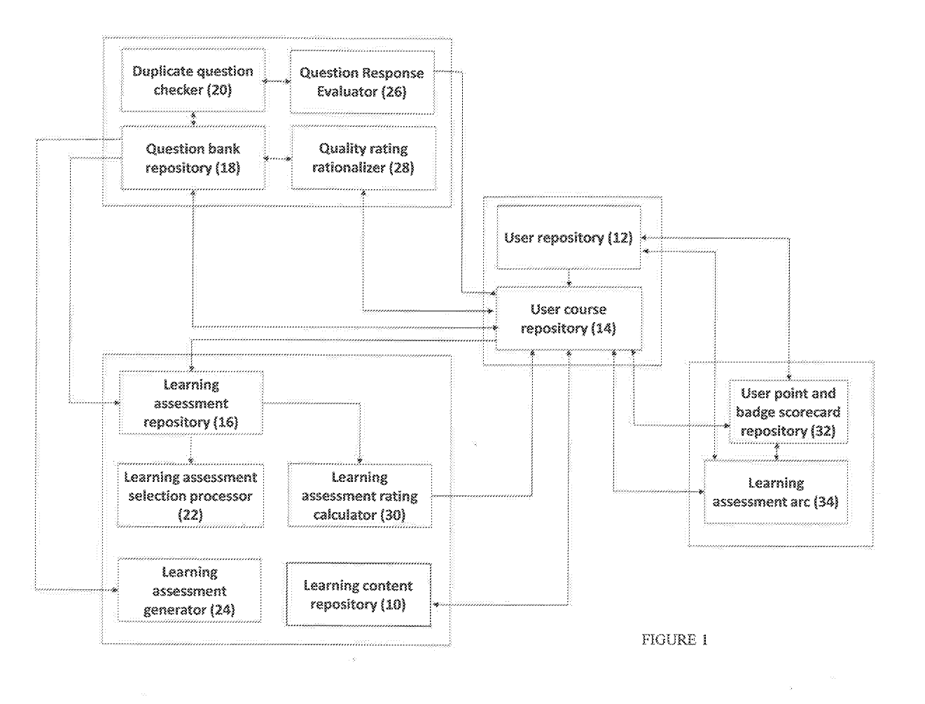

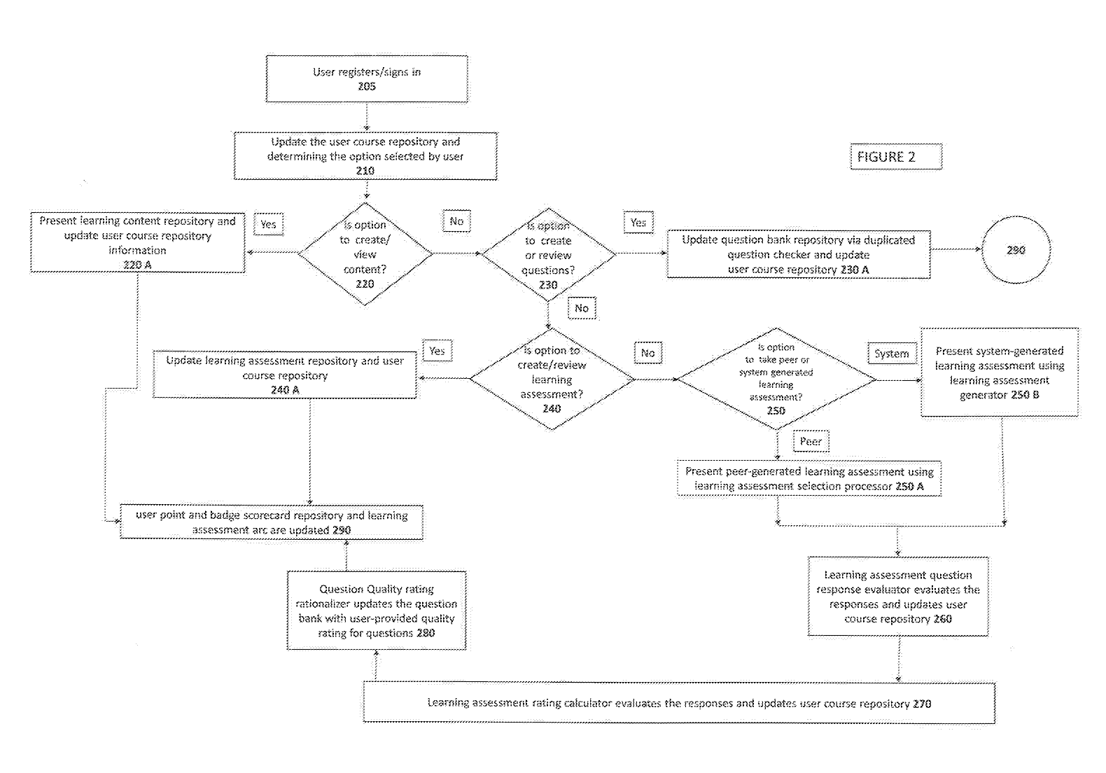

Referring to FIG. 1, there is shown a schematic of a computer implemented network enabled system for structured learning and learning assessment 100 for enabling a learner to create, view or update content, create, take and review learning assessments. The system 100, in accordance with the present disclosure is configured to group users of the system 100 into user roles namely, administrator, moderator, learning assessment creator, learning assessment taker, learning assessment reviewer, learning content creator, learning content reviewer, question creator, question reviewer. In accordance with the present disclosure, an administrator supports system administration functions, ensures proper system implementation, and ensures that appropriate data gathering, data sharing, and maintenance policies are implemented on the system 100. The administrator also performs functions such as editing, adding, deleting, uploading and/or updating and managing the modules to maintain the system 100. A user of the system 100 is one who has registered by creating at least a profile with the system 100 by providing user's credentials. The user can then configure his profile with a second degree authentication by providing biometric identification for the purpose of verifying legitimacy during logging in into the system 100. A moderator is one who is registered with the system 100 and enforces governance on the system 100; he is also the user who has the highest level and maximum no. of privileges in the system. A learning assessment creator is one who is registered with the system 100 and creates the learning assessments in the system 100. A learning assessment taker is one who is registered with the system 100 and takes the learning assessments in the system 100. A learning assessment reviewer is one who is registered with the system 100 and reviews the learning assessment questions in the system 100 in terms of providing quality rating to one or more learning assessment questions. A learning content creator is one who is registered with the system 100 and creates the learning content in the system 100. A learning content reviewer is one who is registered with the system 100 and reviews the learning content in the system. A question creator is one who is registered with the system 100 and creates the questions in the system. A question reviewer is one who is registered with the system 100 and reviews the questions in the system.

The system 100, in accordance with the present disclosure includes a learning content repository 10 for storing learning content in the form of videos, documents, audio files, and/or multiplayer online games, further categorized by learning category or course. It includes a user repository 12 for storing at least user related information and a user profile, which includes without limitation registration information, user level relative to the moderator level, incentive-based points received by the user, user's progress within a group or system. The user repository 12 receives user's credentials and user profile information as received at the time of registration and also receives biometric identification corresponding to the user further authentication during subsequent login actions on the system 100. This biometric identification captured to determine the legitimacy of the user across various logins may include without limitation voice recognition, retina recognition, DNA matching, ear shape recognition, face recognition, finger print recognition, finger geometry recognition, user's behavioral recognition, hand geometry recognition, and signature recognition.

It includes a user course repository 14 to store a plurality of learning courses that a user has registered for and is undertaking at any point of time; number of learning assessments generated by or reviewed or taken by the user, the user's score in each learning assessment, number of learning content assets created or reviewed by the user, number of learning assessment questions generated or reviewed by the user, also a competency indicator which indicates the current and target level of skill level of the user in the particular course. It further includes a learning assessment repository 16 for storing a plurality of user-generated learning assessments as created by and tagged to a learning assessment creator and a learning assessment content tag to indicate which learning content the learning assessment is associated with. It includes a question bank repository 18, a plurality of questions contributing to a learning assessment with associated question types such as True/False, Match the following, Para-jumbles, Multiple choice questions with at least one answer to each of said questions as created by a user, a question creator tag to indicate which user has created the question, a learning content tag to indicate which learning content the question is associated with, a question complexity rating on a scale of 1-10 to indicate the complexity of the question as indicated by the question-creator, a question quality rating on a scale of 1-10 and a question score for each correct/incorrect answer, also a star rating to indicate which questions have ratings above a threshold value. A duplicate question checker 20 possesses the functional elements to compare new questions created by a user with questions in the question bank repository 18 and flag the user in case of a match. A learning assessment selection processor 22 is configured to cooperate with the learning assessment repository 16 to fetch a learning assessment from the learning assessment repository 16 as selected by the learning assessment taker based on the course being undertaken by the user and based on the user's competency indicator information (current and target) from the user course repository 14. A learning assessment generator 24 is configured to fetch set of questions among the ones with the star rating from the question bank repository 18, randomize the questions, and aggregate them into a system-generated learning assessment to be presented to a learning assessment-taker, based on selection of the option to take a system-generated learning assessment, on the course being undertaken by the user and the competency indicator information (current and target) from the user course repository 14. A learning assessment question response evaluator 26 is configured in the system to record the response provided by a user to a question and compare it with the available response for the question in the question bank repository 18, assign a score based on the correctness/incorrectness of the response and recording the question quality rating as provide by the learning assessment-taker. A question quality rating rationalizer 28 possesses functional elements to cooperate with the question bank repository 18 and the user repository 12 to rationalize the question quality rating by adjusting at a question level, the question quality ratings provided by each of the learning assessment-takers by comparing the level of each of the learning assessment takers relative to the level of the moderator as available in the user repository 12, and then further averaging the question quality rating among the number of quality ratings received for a question. Considering an example, if a user has a level of 10 relative to the moderator level of 100, the question quality rating provided by the user will be adjusted by using the calculation−(User's level/Level of the moderator)*(rating given by user for the question). The question quality rating will thus be derived as an average of the respective adjusted question quality ratings provided by different users. Only those questions that receive a quality rating equal to or above a threshold value are retained in the question bank repository with a star rating, the rest are retained but as non-star questions as the question quality rating for the same dips below the threshold value.

A learning assessment rating calculator 30 is configured to derive an aggregate score for the learning assessment based on the scores of the individual questions in the learning assessment undertaken by the user as stored in the learning assessment repository 16 and updating the same in the user course repository;

It further includes a user point and badge scorecard repository 32, to show the points and badges accrued by a user as stored in the user repository 12 on the completion of different activities pertaining to creating, viewing or updating content in the learning content repository 10, creating or taking or reviewing a learning assessment as stored in the learning assessment repository 16, and/or receiving a quality rating for a learning assessment question, such that the points and badges accrued by the user result in enhanced user level relative to the moderator. Indicative list of how the points are accrued for different activities carried out by the user in the system are shown in TABLE 1 below. Also indicated in TABLE 2, is the unlocking of privileges based on different badges that the user receives.

TABLE 1

| | Points awarded |
|---|---|
| Activities performed by user | (indicative) |
| Register for a course in the system | 5 |
| View review learning content (e.g. presentation, video etc.), listen | 10 |
| to an audio-based learning content | |
| Create a video, audio or any other type of learning content | 50 |
| Create questions that are verified by the duplicate question checker | 10 (per question) |
| and are added to the question bank repository | |
| Review questions that are verified by the duplicate question | 5 (per question) |
| checker and are updated into the question bank repository | |
| Take up a learning assessment | 50/25/10 (based |
| | on learning |
| | assessment |
| | aggregate score) |
| Create a learning assessment | 100 |
| Review a learning assessment generated by another user such that it | 50 |
| is updated into the learning assessment repository | |
| Getting quality rating for questions created by him/her above a | 10 (per question) |
| threshold | |
| Getting quality rating for questions created by him/her below a | 0 |
| threshold | |

TABLE 2

| Badge available | Activities that can be performed by user |
|---|---|
| None | 0-499 points |
| Badge Level 1 | On achieving 500 points |
| Badge Level 2 | On achieving 750 points |
| Badge Level 3 | On achieving 1000 points |
| Badge Level 4 | On achieving 2000 points |
| Badge Level 5 | On achieving 5000 points |

It also includes a learning assessment arc 34 that interacts with the user course repository 14, learning assessment repository 16, and user point and badge scorecard repository 32 to provide real-time analytics to reflect learning progress of the user at a granular level. These analytics include the number of courses taken by the user, number of learning content assets created or reviewed by the user, number of learning assessments generated or reviewed or taken by the user, the user's score in each learning assessment, how many questions the user has created, what is the user's score in the different learning assessments undertaken by the user, how many learning assessment questions the user has provided quality feedback for, how many points and badges the user has secured and the user's learning curve in terms of upward shift of the competency indicator and user's level relative to the moderator.

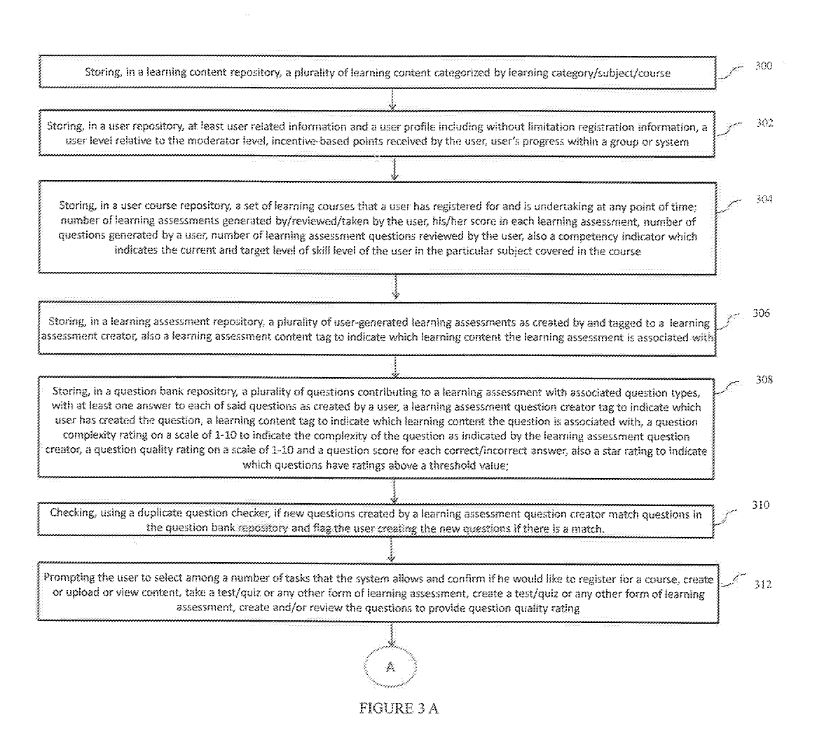

Referring FIG. 2, there is shown an exemplary flowchart for depicting the steps taken by the system 100 of FIG. 1, in accordance with the present disclosure.

Registering/updating profile of a new/existing user in the user repository 205;

Updating the user course repository with current and target skill of the user in particular course as per registration/login details and determining option selected by user 210;

Checking if the user has opted to view or create or update content 220;
if the user has opted to create content, then the learning catalog is presented to him for making necessary additions, and if the user has opted to view or update existing content, the content is presented to him (full list or shortlisted based on course registered for and current and target skill level) for the same and information and content updated into the learning content repository and the user course repository is updated on completion for this activity 220 A;
if the user has not opted to view/create/update content, checking if the user has opted to create or review questions in the question bank repository 230;

If the user has opted to create or review one or more questions, then the same will be stored or updated respectively in the question bank repository after passing it through the duplicate question checker and the user course repository is updated on completion for this activity 230 A;

If the user has not opted to view/create questions, checking if the user has opted to create/review a learning assessment 240;
if the user has opted to create/review a learning assessment for a specific learning category or course, then he is presented questions from the question bank repository for further selection and randomization so that the learning assessment so created/reviewed is updated into the learning assessment repository and the user course repository is updated on completion of this activity 240 A;
if the user has not opted to create a learning assessment, then checking if the user has opted to take a learning assessment created by another user or a system-generated learning assessment 250;
   If the user has opted to take a learning assessment created by another user in the system, then the learning assessment selection processor enables selection of the learning assessment from the learning assessment repository and presents it to him 250 A;
   if the user has opted to take a learning assessment generated by the system, then the learning assessment generator fetches the star rated questions from the question bank repository, randomizes them and aggregates them into a learning assessment and assigns them to the user 250 B;
   On completion of the learning assessment, the learning assessment question response evaluator evaluates each response with the stored question response in the question bank repository and assigns the score to the user for the same as per the accuracy of the response and updates the user course repository 260;
   Once the individual scores are computed for the learning assessment, the learning assessment rating calculator then aggregates the total of the learning assessment as scored by the user based on the scores of the individual questions in the learning assessment undertaken by the user and the user course repository is updated 270;
   Further, the question quality rating rationalizer updates the question bank after capturing the user feedback for quality of the questions and adjusting the same as per difference between user level and moderator level 270;
   On individual completion of the steps 220 A, 230 A, 240 A and 280, the user course repository updates the user point and badge repository and learning assessment arc for the user 230;

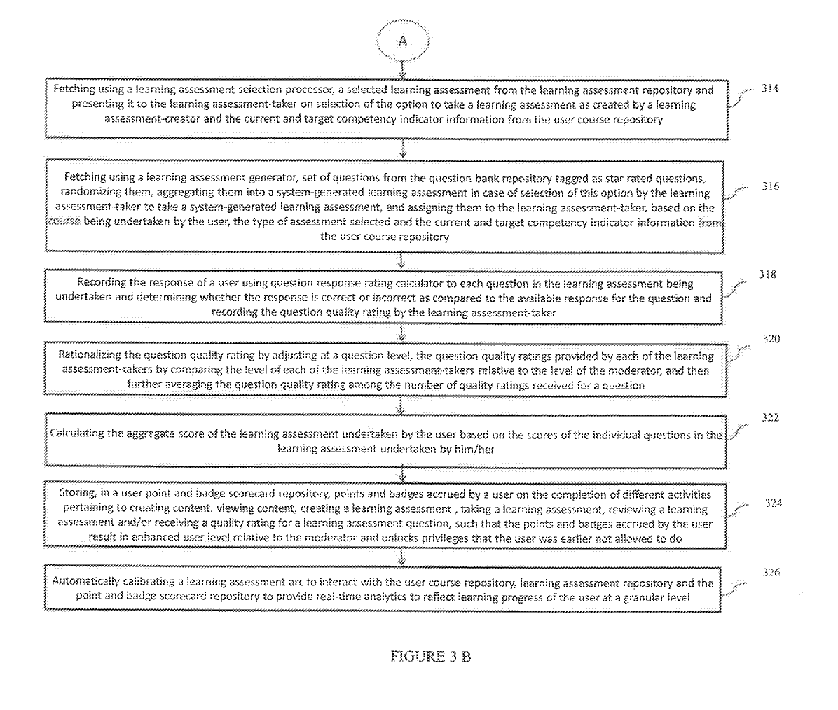

Referring to FIG. 3(a) and FIG. 3(b), a method for providing structured online learning and learning assessment is illustrated through flow diagrams. The method envisaged by the present disclosure includes the following steps:

storing, in a learning content repository, a plurality of learning content categorized by learning category or course 300;
storing, in a user repository, at least user related information and a user profile including without limitation registration information, a user level relative to the moderator level, incentive-based points received by the user, user's progress within a group or system 302;
storing, in a user course repository, a set of learning courses that a user has registered for and is undertaking at any point of time; number of learning content assets viewed or created or reviewed by the user, number of learning assessments generated by, reviewed or taken by the user, the user's score in each learning assessment, number of learning assessment questions generated or reviewed by a user, also a competency indicator which indicates the current and target level of skill level of the user in the particular course 304;
2. storing, in a learning assessment repository, a plurality of user-generated learning assessments as created by and tagged to a learning assessment creator, also a learning assessment content tag to indicate which learning content the learning assessment is associated with 306;
storing, in a question bank repository, a plurality of questions contributing to a learning assessment with associated question types, with at least one answer to each of said questions as created by a user, a question creator tag to indicate which user has created the question, a learning content tag to indicate which learning content the question is associated with, a question complexity rating on a scale of 1-10 to indicate the complexity of the question as indicated by the learning assessment question-creator, a question quality rating on a scale of 1-10 and a question score for each correct/incorrect answer, also a star rating to indicate which questions have ratings above a threshold value 308;
checking, using a duplicate question checker, if new questions created by a learning assessment question-creator match questions in the question bank repository and flag the user creating the new questions if there is a match 310;
prompting the user to select among a number of tasks that the system allows and confirm if he would like to register for a course, create or review content, create or review a set of questions, take a test/quiz or any other form of learning assessment, create or review a test/quiz or any other form of learning assessment or create questions or review the questions to provide question quality rating 312;
fetching using a learning assessment selection processor, a selected learning assessment from the learning assessment repository and presenting it to the learning assessment-taker on selection of the option to take a learning assessment as created by a learning assessment-creator and the competency indicator information (current and target) from the user course repository 314;
fetching using a learning assessment generator, set of questions from the question bank repository tagged as star rated questions, randomizing them, aggregating them into a system-generated learning assessment in case of selection of this option by the learning assessment-taker to take a system-generated learning assessment, and assigning them to the learning assessment-taker, based on the course being undertaken by the user, the type of assessment selected and the competency indicator information (current and target) from the user course repository 316;
recording the response of the user to each question in the learning assessment being undertaken and determining whether the response is correct or incorrect as compared to the available response for the question and recording the question quality rating by the learning assessment-taker 318;
rationalizing the question quality rating by adjusting at a question level, the question quality ratings provided by each of the learning assessment-takers by comparing the level of each of the learning assessment-takers relative to the level of the moderator, and then further averaging the question quality rating among the number of quality ratings received for a question 320;
calculating the aggregate score of the learning assessment undertaken by the user based on the scores of the individual questions in the learning assessment undertaken by him/her 322;
storing, in a user point and badge scorecard repository, points and badges accrued by a user on the completion of different activities pertaining to creating, viewing or updating content, creating a learning assessment, taking a learning assessment, reviewing a learning assessment and/or receiving a quality rating for a learning assessment question, such that the points and badges accrued by the user result in enhanced user level relative to the moderator 324;
automatically calibrating the learning assessment arc to interact with the user course repository, learning assessment repository and user point and badge scorecard repository to provide real-time analytics to reflect learning progress of the user at a granular level 326;

The technical advancements of the system as envisaged by the present disclosure include without limitation, the realization of computer implemented network enabled online learning and learning assessment as a gamified platform for improving a user's progressive structured and progressive learning in a plurality of learning categories or courses by allowing the user to engage with the other users in learning assessments and related activities in the context of specific learning courses that the user wishes to learn. The learning assessment arc is an intelligent mechanism to carry out granular and real-time measurement of the learner's progress to close the gap between the user level and the moderator who has the highest level and maximum no. of privileges in the system.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language. Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A computer implemented network enabled system for structured and progressive online learning and learning assessment, the system comprising:
a learning content repository for storing a plurality of learning contents;
a user repository for storing a plurality of user profiles wherein a first user is designated as a moderator and a second user has a user level relative to the first user, and wherein one or more second users is at least one of a learning content creator, a learning content reviewer, a question creator, a question reviewer, a learning assessment creator, a learning assessment reviewer and a learning assessment taker;
a question bank repository for storing a plurality of questions and at least one answer to each of said questions from amongst the plurality of questions;
a learning assessment repository for storing a plurality of learning assessments as created by the second user from a plurality of users;
a user course repository for storing a plurality of learning courses registered for by the second user from said user repository, number of learning content assets from said learning content repository viewed or created or reviewed by the second user, number of learning assessments created by or taken or reviewed by the second user, the second user's score in each learning assessment, number of learning assessment questions created or reviewed by the second user in said question bank repository, and a competency indicator which indicates the current and target skill level of the second user in the particular course;
a duplicate question checker configured to check if a new question created by the question creator from said user repository matches any question in said question bank repository and send a system message to the question creator in case of a match;
a learning assessment selection processor configured to cooperate with said learning assessment repository to fetch a learning assessment from said learning assessment repository selected by the learning assessment taker from said user repository based on selection of the option by the learning assessment taker to take a learning assessment as created by a learning assessment creator and based on the learning assessment taker's competency indicator information from said user course repository;
a learning assessment generator configured to create a learning assessment by fetching a set of questions from said question bank repository among the questions tagged with star rating, randomizing the said questions, and aggregating them into a system-generated learning assessment to be presented to a learning assessment taker, based on selection of the option by the learning assessment-taker to take a system-generated learning assessment, on the course being undertaken by the learning assessment taker, the type of assessment selected and the competency indicator information of the learning assessment taker from said user course repository;
a learning assessment question response evaluator configured in the system to record the response provided by the learning assessment taker from said user repository to each question in the learning assessment from said learning assessment repository or generated by the learning assessment generator and compare it with the available response for said question in said question bank repository, assign a score based on the correctness or incorrectness of the response and record the question quality rating for the said question in the question bank repository as provided by the learning assessment-taker;
a question quality rating rationalizer configured to cooperate with said question bank repository and said user repository to rationalize the question quality rating for each question in said question bank repository by adjusting at a question level, the question quality ratings provided by each of the plurality of the learning assessment takers by comparing the level of each learning assessment-taker relative to the level of the first user as available in said user repository, and then further averaging the question quality rating among the number of quality ratings received for said question in said question bank repository;
a learning assessment rating calculator configured to calculate the aggregate score of the learning assessment taken by the learning assessment taker from said user repository by aggregating the scores for each question in the said learning assessment;
a user point and badge scorecard repository configured to show the points and badges accrued by the second user on the completion of different activities pertaining to creating, viewing or updating learning content in said learning content repository, creating, taking or reviewing a learning assessment in said learning assessment repository, receiving a question quality rating for a question in said question bank repository, such that the points and badges accrued by the second user results in enhanced user level relative to the first user in said user repository and unlocks privileges that the second user was earlier not allowed to do; and
a learning assessment arc configured to interact with said user repository, said user course repository, said learning assessment repository, and said user point and badge scorecard repository to provide real-time analytics to reflect learning progress of the second user at a granular level.

2. The system as claimed in claim 1, wherein the plurality of learning content in the said learning content repository is categorized by learning category or course and is stored in the form of videos, documents, audio files, and multiplayer online games.

3. The system as claimed in claim 1, wherein said user repository is further configured to store user information including at least registration information, incentive-based points received by the second user and the second user's progress within a group or system.

4. The system as claimed in claim 1, wherein said question bank repository is configured to include a question type tag to tag each question with at least one of a plurality of question types including True or False statement, Match the following statement, Para-jumbles statement, and multiple choice questions, with at least one answer to each of the said questions as created by the second user; a question creator tag to tag each question with a user identifier that is indicative of creation of said question, wherein said user identifier is associated with a specific second user from said user repository, a learning content tag to tag said question with a learning content identifier that is indicative of the learning content obtained from said learning content repository, a question complexity rating to indicate the complexity of the question, a question quality rating to tag a quality rating for said question, a question score to score a response for each question, and a star rating to indicate which questions have quality ratings above a defined threshold value.

5. The system as claimed in claim 1, wherein a learning assessment creator tag is configured in said learning assessment repository to tag each learning assessment with a user identifier that is indicative of creation of said learning assessment, wherein said user identifier is associated with the second user from said user repository and a learning assessment content tag is configured to tag a learning assessment with a learning content from said learning content repository.

6. The system as claimed in claim 1, wherein said learning are is configured to include the number of courses from said user course repository taken by each second user from a plurality of users, number of content based assets created, viewed or reviewed by the second user from the said user course repository, number of learning assessments generated by or taken or reviewed by the second user, the second user's score in each learning assessment from a plurality of learning assessments from said user course repository, no. of questions created or reviewed by the second user from said user course repository, no. of questions the second user from said user course repository has provided quality feedback for, the points and badges earned by the second user from said user point and badge scorecard repository, and the competency indicator of the second user in the courses from said user course repository, and the user level of the second user relative to the first user from said user repository.

7. A computer implemented method for providing structured and progressive online learning and learning assessment, the method comprising:
storing, in a learning content repository, a plurality of learning contents;
storing, in a user repository, a plurality of user profiles wherein a first user is designated as a moderator and a second user has a user level relative to the first user and one or more second users is at least one of a learning content creator, a learning content reviewer, a question creator, a question reviewer, a learning assessment creator, a learning assessment reviewer and a learning assessment taker;
storing, in a question bank repository a plurality of questions and at least one answer to each of said questions;
storing, in a learning assessment repository, a plurality of learning assessments as created by the second user from a plurality of users;
storing, in a user course repository, a plurality of learning courses registered for by the second user from said user repository, number of learning content assets from said learning content repository viewed or created or reviewed by second user, number of learning assessments created by or taken or reviewed by the second user, the second user's score in each learning assessment, number of learning assessment questions created or reviewed by second user in said question bank repository, a competency indicator which indicates the current and target skill level of the second user in the particular course;
checking, using a duplicate question checker, if a new question created by the question creator from said user repository matches any question in said question bank repository and sending a system message to the second user in case of a match;
prompting the second user to select among a number of tasks that the system allows and confirm if he would like to create, view or review learning content in said learning content repository, take a test/quiz or any other form of learning assessment from said learning assessment repository, create or review a test/quiz or any other form of learning assessment into said learning assessment repository or create questions or review the questions in said question bank repository to provide question quality rating;
fetching using a learning assessment selection processor, a learning assessment from said learning assessment repository and presenting it to the learning assessment taker from said user repository based on selection of the option by the learning assessment taker to take a learning assessment as created by a learning assessment-creator from said user repository and based on the learning assessment taker's competency indicator information from said user course repository;
using a learning assessment generator to fetch one or more from a plurality of questions from the said question bank repository tagged with star rating, randomizing the said questions, and aggregating them into a system-generated learning assessment to be presented to a learning assessment taker, based on selection of the option by the learning assessment-taker to take a system-generated learning assessment, on the course being undertaken by the learning assessment taker user, the type of assessment selected and the competency indicator information of the learning assessment taker from said user course repository;
using the learning assessment question response evaluator to record the response of the learning assessment taker from said user repository to each question in the learning assessment from said learning assessment repository or generated by the learning assessment generator and compare it with the available response for the said question in the said question bank repository, assign a score based on the correctness or incorrectness of the response and record the question quality rating for the said question in the question bank repository as provided by the learning assessment-taker;
using the question quality rating rationalizer to rationalize the question quality rating for each question in said question bank repository by adjusting at a question level, the question quality ratings provided by each of the plurality of learning assessment-takers by comparing the level of each learning assessment taker relative to the level of the first user as available in the said user repository, and then further averaging the question quality rating among the number of quality ratings received for said question in said question bank repository;
using the learning assessment rating calculator to calculate the aggregate score of the learning assessment taken by the learning assessment taker from said user repository by aggregating the scores for the each question in the said learning assessment;
storing, in a user point and badge scorecard repository, the points and badges accrued by the second user on the completion of different activities pertaining to creating, viewing or updating learning content in said learning content repository, creating, taking or reviewing a learning assessment in said learning assessment repository, receiving a quality rating for a question in said question bank repository, such that the points and badges accrued by the second user results in enhanced user level relative to the first user in said user repository and unlocks privileges that the second user was earlier not allowed to do; and
automatically calibrating a learning assessment arc to interact with said user course repository, said learning assessment repository and said user point and badge scorecard repository to provide real-time analytics to reflect learning progress of the second user at a granular level.

8. The method as claimed in claim 7, wherein the step of storing the plurality of learning content in the said learning repository further includes the step of categorizing the said learning content by learning category or course and storing the learning content in the form of videos, documents, audio files, and multiplayer online games.

9. The method as claimed in claim 7, wherein the step of storing user information in a user repository, further includes the step of storing at least registration information, incentive-based points received by the second user and the second user's progress within a group or system.

10. The method as claimed in claim 7, wherein the step of storing a plurality of questions in the question bank repository includes the step of storing a question type tag to tag each question with at least one of a plurality of question types including True or False statement, Match the following statement, Para-jumbles statement, and multiple choice questions, with at least one answer to each of the said questions as created by the second user; a question creator tag to tag each question with a user identifier that is indicative of creation of said question, wherein said user identifier is associated with a specific second user from said user repository, a learning content tag to tag said question with a learning content identifier that is indicative of the learning content obtained from said learning content repository, a question complexity rating to indicate the complexity of the question, a question quality rating to tag a quality rating for said question, a question score to score a response for each question, and a star rating to indicate which questions have quality ratings above a defined threshold value

11. The method as claimed in claim 7, wherein the step of storing a plurality of learning assessments in said learning assessment repository further includes the step of tagging each learning assessment with a user identifier that is indicative of creation of said learning assessment, wherein each user identifier is associated with the second user from said user repository and tagging each learning assessment content with a learning assessment content tag from said learning content repository.

12. The method as claimed in claim 7, wherein the step of configuring the said learning arc further includes the step of storing the number of courses from said user course repository taken by each second user from a plurality of users, number of content based assets created, viewed or reviewed by the second user from the said user course repository, number of learning assessments generated by or taken or reviewed by the second user, the second user's score in each learning assessment from a plurality of learning assessments from said user course repository, no. of questions created or reviewed by the second user from said user course repository, no. of questions the second user from said user course repository has provided quality feedback for, the points and badges earned by the second user from said user point and badge scorecard repository, the competency indicator of the second user in the courses from said user course repository, and the user level of the second user relative to the first user from said user repository.
